(19) United States
(12) Patent Application Publication
(10) Pub. No.: US 2026/0219693 A1
(43) Pub. Date: Jul. 30, 2026

(54) METHOD OF DETERMINING RELIABILITY AMONG PLURALITY OF AUTONOMOUS MOBILE ROBOTS AND APPARATUS FOR PERFORMING THE SAME

(71) Applicant: Electronics and Telecommunications Research Institute, Daejeon (KR)

(72) Inventors: Taehyoung SHIM, Sejong-si (KR); Jun Seob LEE, Daejeon (KR); Jeongil YIM, Daejeon (KR)

(73) Assignee: Electronics and Telecommunications Research Institute, Daejeon (KR)

(21) Appl. No.: 19/420,950

(22) Filed: Dec. 16, 2025

(30) Foreign Application Priority Data
Jan. 24, 2025 (KR) 10-2025-0011076
Nov. 13, 2025 (KR) 10-2025-0171960

(51) Int. Cl. G05D 1/86; G05D 1/697; H04L 9/08; G05D 105/20; G05D 109/10; G05D 111/30

(52) U.S. Cl. CPC G05D 1/86; G05D 1/697; H04L 9/0825; G05D 2105/20; G05D 2109/10; G05D 2111/30; H04L 2209/84

(57) ABSTRACT

A method of coordinating priority among a plurality of autonomous mobile robots and an apparatus for performing the same are disclosed. A method of operating a first delivery robot service provider that manages a first delivery robot includes obtaining, when the first delivery robot meets a second delivery robot in commonly used infrastructure, an identifier of the second delivery robot, obtaining, based on the identifier of the second delivery robot, information of a second delivery robot service provider that manages the second delivery robot, and negotiating, based on the information of the second delivery robot service provider, a priority for use of the commonly used infrastructure between the first delivery robot and the second delivery robot.

### CROSS-REFERENCE TO RELATED APPLICATIONS

This application claims the benefit of Korean Patent Application No. 10-2025-0011076, filed on January 24, 2025, and Korean Patent Application No. 10-2025-0171960, filed on November 13, 2025, in the Korean Intellectual Property Office, the entire disclosures of which are incorporated herein by reference for all purposes.

### BACKGROUND

### 1. Field of the Invention

One or more embodiments relate to a method of determining reliability among a plurality of autonomous mobile robots and an apparatus for performing the same.

### 2. Description of the Related Art

An autonomous delivery robot service may refer to a service in which a delivery robot delivers goods by interworking with urban infrastructure and other entities.

To support the autonomous delivery robot service, an interworking protocol among entities (e.g., delivery robots, service providers, users, and infrastructure) may be required.

The above description is information the inventor(s) acquired during the course of conceiving the present disclosure, or already possessed at the time, and is not necessarily art publicly known before the present application was filed.

### SUMMARY

Embodiments provide an interworking method for an autonomous delivery robot-based delivery service.

However, the technical goals are not limited to those described above, and other technical goals may be present.

According to an aspect, there is provided a method of operating a first delivery robot, the method including receiving, when the first delivery robot meets a second delivery robot in commonly used infrastructure, an identifier of the second delivery robot and a first public key corresponding to the identifier from the second delivery robot, receiving, when the first delivery robot meets a third delivery robot in the commonly used infrastructure, a second public key corresponding to the identifier of the second delivery robot from the third delivery robot, determining whether the first public key is the same as the second public key, and adjusting, based on the determining, a reliability of the second delivery robot.

The adjusting of the reliability of the second delivery robot may include increasing the reliability of the second delivery robot when the first public key is the same as the second public key and decreasing the reliability of the second delivery robot when the first public key is not the same as the second public key.

The method may further include determining the second delivery robot to be an unreliable delivery robot when the reliability of the second delivery robot is less than a threshold reliability.

The method may further include transmitting, when the first delivery robot meets the second delivery robot in the commonly used infrastructure after the second delivery robot is determined to be the unreliable delivery robot, information indicating that the second delivery robot is the unreliable delivery robot to a first delivery robot service provider that manages the first delivery robot.

The method may further include registering the identifier of the second delivery robot in a first identifier ledger of the first delivery robot.

The registering of the identifier of the second delivery robot may include generating a current block in which the identifier of the second delivery robot is registered through a block generation operation between a previous block of the first identifier ledger and the first public key.

The determining of whether the first public key is the same as the second public key may include generating the first public key based on the previous block and the current block and determining whether the generated first public key is the same as the second public key.

The first identifier ledger may be a ledger in which identifiers of delivery robots met by the first delivery robot are registered.

A second identifier ledger, which is a ledger in which identifiers of delivery robots met by the third delivery robot are registered, may include the identifier of the second delivery robot.

According to another aspect, there is provided a first delivery robot including a processor and a memory configured to store instructions, in which the instructions, when executed by the processor, cause the first delivery robot to perform a plurality of operations, the plurality of operations including receiving, when the first delivery robot meets a second delivery robot in commonly used infrastructure, an identifier of the second delivery robot and a first public key corresponding to the identifier from the second delivery robot, receiving, when the first delivery robot meets a third delivery robot in the commonly used infrastructure, a second public key corresponding to the identifier of the second delivery robot from the third delivery robot, determining whether the first public key is the same as the second public key, and adjusting, based on the determining, a reliability of the second delivery robot.

The adjusting of the reliability of the second delivery robot may include increasing the reliability of the second delivery robot when the first public key is the same as the second public key and decreasing the reliability of the second delivery robot when the first public key is not the same as the second public key.

The plurality of operations may further include determining the second delivery robot to be an unreliable delivery robot when the reliability of the second delivery robot is less than a threshold reliability.

The plurality of operations may further include transmitting, when the first delivery robot meets the second delivery robot in the commonly used infrastructure after the second delivery robot is determined to be the unreliable delivery robot, information indicating that the second delivery robot is the unreliable delivery robot to a first delivery robot service provider that manages the first delivery robot.

The plurality of operations may further include registering the identifier of the second delivery robot in a first identifier ledger of the first delivery robot.

The registering of the identifier of the second delivery robot may include generating a current block in which the identifier of the second delivery robot is registered through a block generation operation between a previous block of the first identifier ledger and the first public key.

The determining of whether the first public key is the same as the second public key may include generating the first public key based on the previous block and the current block and determining whether the generated first public key is the same as the second public key.

The first identifier ledger may be a ledger in which identifiers of delivery robots met by the first delivery robot are registered.

A second identifier ledger, which is a ledger in which identifiers of delivery robots met by the third delivery robot are registered, may include the identifier of the second delivery robot.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1 and 2 are diagrams each illustrating a delivery robot service system according to an embodiment;

FIG. 3 is a schematic flowchart illustrating a workflow of a delivery robot service according to an embodiment;

FIG. 4 is a flowchart illustrating the delivery robot service system according to an embodiment;

FIG. 5 is a diagram illustrating a delivery robot service system according to an embodiment;

FIG. 6 is a diagram illustrating a delivery method based on an autonomous mobile robot according to an embodiment;

FIG. 7 is a diagram illustrating a delivery robot service system according to an embodiment;

FIG. 8 is a flowchart illustrating a method of verifying the reliability of identifiers among a plurality of delivery robots according to an embodiment;

FIG. 9 is a flowchart illustrating a method of registering an identifier in an identifier ledger according to an embodiment;

FIG. 10 is a diagram illustrating a method of verifying identifiers among a plurality of delivery robots according to an embodiment;

FIG. 11 is a schematic block diagram illustrating a delivery robot according to an embodiment; and

FIG. 12 is a schematic block diagram illustrating a delivery robot service provider according to an embodiment.

### DETAILED DESCRIPTION

The following detailed structural or functional description is provided as an example only and various alterations and modifications may be made to the examples. Accordingly, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is "connected", "coupled", or "joined" to another component, a third component may be "connected", "coupled", and "joined" between the first and second components, although the first component may be directly connected, coupled, or joined to the second component.

The singular forms "a," "an," and "the" are intended to include the plural forms as well, unless the context clearly indicates otherwise. As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof. It will be further understood that the terms "comprises/including" and/or "includes/including" when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used in connection with the present disclosure, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an example, the module may be implemented in a form of an application-specific integrated circuit (ASIC).

The term "unit" used herein may refer to a software or hardware component, such as a field-programmable gate array (FPGA) or an ASIC, and the "unit" performs predefined functions. However, "unit" is not limited to software or hardware. The "unit" may be configured to reside on an addressable storage medium or configured to operate one or more processors. Accordingly, the "unit" may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and "units" may be combined into fewer components and "units" or may be further separated into additional components and "units." Furthermore, the components and "units" may be implemented to operate on one or more central processing units (CPUs) within a device or a security multimedia card. In addition, "unit" may include one or more processors.

Hereinafter, the examples will be described in detail with reference to the accompanying drawings. When describing the embodiments with reference to the accompanying drawings, like reference numerals refer to like elements and a repeated description related thereto will be omitted.

Although the embodiments described below use a delivery robot for ease of description, the embodiments may be applied to any delivery robot that is capable of autonomous driving and/or remote control. The embodiments are not limited to delivery robots.

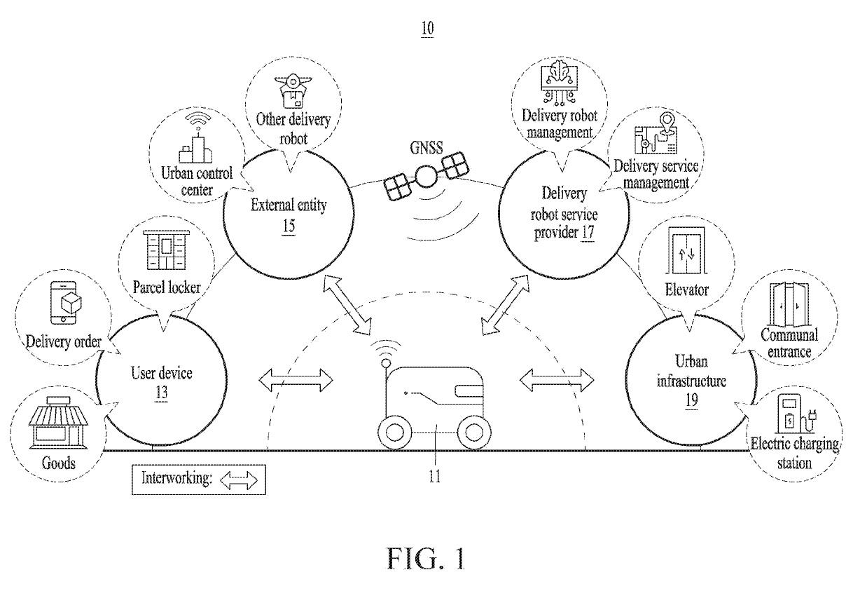

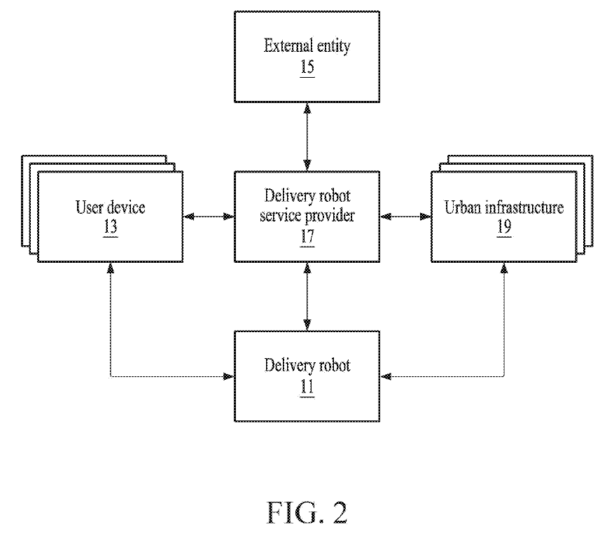

FIGS. 1 and 2 are diagrams each illustrating a delivery robot service system according to an embodiment.

Referring to FIGS. 1 and 2, according to an embodiment, a delivery robot service system 10 may include a delivery robot 11, a user device 13, an external entity 15, a delivery robot service provider 17, and urban infrastructure 19.

The delivery robot 11 may deliver goods based on a delivery request of a user. The delivery robot 11 may include an autonomous driving-based robot. The delivery robot 11 may directly interwork with the user device 13, the delivery robot service provider 17, and the urban infrastructure 19. The delivery robot 11 may indirectly interwork with the external entity 15 through the delivery robot service provider 17.

The delivery robot 11 may share information (e.g., identifiers or capabilities) regarding the delivery robot 11 with the delivery robot service provider 17.

The delivery robot 11 may share delivery status information (e.g., a current location of the delivery robot 11, a loading status of the goods, the type of goods, or a status of the goods) with the delivery robot service provider 17.

The delivery robot 11 may identify at least one user device related to the goods to be delivered. For example, the delivery robot 11 may identify a user device related to the loading of the goods and a user device (e.g., a user device of a recipient) related to the unloading of the goods.

When the goods are loaded or unloaded by an object (e.g., a person or another robot) that is not the delivery robot 11, the delivery robot 11 may notify the delivery robot service provider 17 that the delivery robot 11 is waiting for the loading or unloading of the goods after arriving at a pick-up location or a delivery location.

The delivery robot 11 may receive information indicating that the loading or the unloading is completed from the object (e.g., the person or the other robot) responsible for the loading or unloading of the goods. After receiving the information, the delivery robot 11 may notify the delivery robot service provider 17 that the loading or the unloading is completed.

When the goods are loaded or unloaded by the delivery robot 11, the delivery robot 11 may notify the delivery robot service provider 17 that the loading or the unloading is completed after completing the loading or unloading of the goods.

After arriving at the urban infrastructure 19, the delivery robot 11 may notify the delivery robot service provider 17 that the delivery robot 11 is waiting to access the urban infrastructure 19.

The delivery robot 11 may request the delivery robot service provider 17 to transmit additional information needed to access the urban infrastructure 19 or for autonomous driving.

The delivery robot 11 may maintain time synchronization with the delivery robot service provider 17.

When an event (e.g., the breakdown of the delivery robot 11) that may impede delivery occurs, the delivery robot 11 may notify the delivery robot service provider 17 of information related to the event. The delivery robot 11 may take actions needed to resolve the event.

The delivery robot 11 may directly interwork with the user device 13, the urban infrastructure 19, and another delivery robot, as needed. For example, the delivery robot 11 may directly interwork with the other delivery robot when a collision with the other delivery robot that is within a preset distance (or a distance sensible by a sensor) from the delivery robot 11 is predicted. The delivery robot 11 may directly interwork with the other delivery robot when congestion caused due to the sharing of a narrow space (e.g., a staircase) between the delivery robot 11 and the other delivery robot is predicted. The delivery robot 11 may calculate a congestion level based on at least one of the area of a space surrounding the delivery robot 11, the type of space surrounding the delivery robot 11, the size of the delivery robot 11, and the size of the other delivery robot. For example, the delivery robot 11 may determine the congestion level to be higher as the space (e.g., an elevator) surrounding the delivery robot 11 is more likely to be occupied by people. The delivery robot 11 may directly interwork with the other delivery robot when the congestion level satisfies a threshold. The delivery robot 11 may directly interwork with the urban infrastructure 19 when communication with the delivery robot service provider 17 fails. The delivery robot 11 may directly interwork with the user device 13 when the delivery robot 11 needs to move to a location in proximity to the user device 13, or user authentication is needed.

The delivery robot 11 may notify the delivery robot service provider 17 of a result of direct interworking.

The delivery robot 11 may interwork with the other delivery robot through the delivery robot service provider 17.

The delivery robot 11 may receive a request to preferentially process a particular task from the delivery robot service provider 17. The delivery robot 11 may preferentially process the requested task. The delivery robot 11 may transmit a result of processing the requested task to the delivery robot service provider 17.

The user device 13 may include at least one device. For example, the user device 13 may include at least one of a device of a delivery requester, a device related to the loading of the goods, and a device related to the unloading of the goods. The device may include an electronic device, such as a mobile device and a computing device, that is operated by the user and/or an unattended electronic device that may store and/or manage the goods. The user device 13 may directly interwork with the delivery robot service provider 17 and the delivery robot 11.

The user device 13 may provide a function (e.g., a user interface) of receiving a delivery request from the user and providing the user with delivery status information.

The user device 13 may transmit delivery information input by the user to the delivery robot service provider 17.

The user device 13 may collect the location information of the user device 13.

When receiving information that needs to be confirmed or processed by the user, the user device 13 may notify the user of the reception of the information by using various means (e.g., sound, vibration, or light).

The user device 13 may directly interwork with the delivery robot 11 that is located near the user device 13. For example, the user device 13 may directly interwork with the delivery robot 11 when the delivery robot 11 is within a preset distance from the user device 13.

When receiving a request for the loading or unloading of the goods from the delivery robot service provider 17, the user device 13 may notify the user (e.g., a person in charge of loading or a recipient) of the reception of the request.

The user device 13 may notify the delivery robot service provider 17 that the loading or unloading of the goods is completed.

The external entity 15 may include a device (e.g., a server) of a public institution (e.g., an urban control center, a disaster management agency, or an emergency rescue agency) and a device (e.g., a server) of another delivery robot service provider. The external entity 15 may directly interwork with the delivery robot service provider 17.

The delivery robot service provider 17 may include a device, such as a server. The delivery robot service provider 17 may manage the delivery robot 11. The delivery robot service provider 17 may directly interwork with the delivery robot 11, the user device 13, the external entity 15, and the urban infrastructure 19.

The delivery robot service provider 17 may retain and/or manage the information (e.g., the identifiers or the capabilities) regarding the delivery robot 11.

The delivery robot service provider 17 may collect and manage information (e.g., locations, identifiers, or capabilities) regarding the urban infrastructure 19.

The delivery robot service provider 17 may determine whether there is an available delivery robot (e.g., the delivery robot 11) in response to receiving a delivery request from the user device 13. The delivery robot service provider 17 may transmit information (e.g., delivery request approval or delivery request rejection) to the user device 13 based on the available delivery robot.

The delivery robot service provider 17 may identify at least one user device related to the received delivery request. For example, the delivery robot service provider 17 may identify a user device of the delivery requester, the user device related to the loading of the goods, and the user device (e.g., the user device of the recipient) related to the unloading of the goods.

The delivery robot service provider 17 may generate delivery information regarding the delivery request. The delivery information may include at least one of a pick-up location, a delivery location, a delivery time, information (e.g., a location or an identifier) regarding infrastructure that needs to interwork with a delivery robot, a delivery route, the type of goods, the weight of the goods, the size of the goods, and a delivery condition (e.g., an appropriate temperature).

The delivery robot service provider 17 may assign the delivery robot 11 simultaneously with or separately from generating a delivery request.

The delivery robot service provider 17 may collect a current location of the delivery robot 11, a movement direction of the delivery robot 11, a status (e.g., breakdown or a battery status) of the delivery robot 11, a goods loading status of the delivery robot 11, or a status (e.g., a temperature) of the goods.

The delivery robot service provider 17 may transmit the delivery status information generated by the delivery robot 11 to the user device 13.

After the delivery robot 11 arrives at the pick-up location or the delivery location, the delivery robot service provider 17 may notify the user device 13 that the delivery robot 11 is waiting to load or unload the goods.

The delivery robot service provider 17 may notify the urban infrastructure 19 that the delivery robot 11 is waiting to interwork with the urban infrastructure 19 after the delivery robot 11 arrives at the urban infrastructure 19.

The delivery robot service provider 17 may notify the delivery robot 11 of a response (e.g., a result of an interworking request), which is received from the urban infrastructure 19, to the interworking request.

The delivery robot service provider 17 may collect additional information other than the delivery information from the urban infrastructure 19 and/or the external entity 15. The delivery robot service provider 17 may provide the collected additional information to the delivery robot 11.

The delivery robot service provider 17 may receive information indicating the loading or unloading of the goods is completed from the user device 13. The delivery robot service provider 17 may transmit the received information to the delivery robot 11.

The delivery robot service provider 17 may receive information indicating that the loading or unloading of the goods is completed from the delivery robot 11. The delivery robot service provider 17 may transmit the received information to the user device 13.

The delivery robot service provider 17 may determine whether the delivery robot 11 may continue to deliver the goods, based on the delivery status information generated by the delivery robot 11.

The delivery robot service provider 17 may receive a result of direct interworking from the delivery robot 11. The delivery robot service provider 17 may update the delivery information in response to receiving the result.

The delivery robot service provider 17 may receive a request from the external entity 15. For example, the external entity 15 may request the delivery robot service provider 17 to transmit visual information regarding a space surrounding the delivery robot 11. The delivery robot service provider 17 may evaluate (or determine) the request (e.g., the content of the request) from the external entity 15. The delivery robot service provider 17 may divide the request from the external entity 15 into an urgent request and a non-urgent request. The delivery robot service provider 17 may notify the delivery robot 11 of the request from the external entity 15. For example, when the request from the external entity 15 needs to be processed preferentially, the delivery robot service provider 17 may transmit priority information of the request together with the request from the external entity 15 to the delivery robot 11.

The delivery robot service provider 17 may process the request from the external entity 15 and may notify the external entity 15 of a processing result.

The delivery robot service provider 17 may determine a priority among a plurality of delivery robots when the plurality of delivery robots is waiting to interwork with the same urban infrastructure. The priority may be an order for the plurality of delivery robots to use the urban infrastructure. The delivery robot service provider 17 may use the delivery status information (e.g., the type of goods or a status of the goods) of each of the plurality of delivery robots to determine the priority.

The delivery robot service provider 17 may receive a result of interworking (e.g., direct interworking) between the delivery robot 11 and another delivery robot from the delivery robot 11. The delivery robot service provider 17 may determine, from the received result, that the other delivery robot is managed by another delivery service provider. The delivery robot service provider 17 may determine, from the received result, that the delivery robot 11 and the other delivery robot are waiting to interwork with the same urban infrastructure. The delivery robot service provider 17 may interwork with the other delivery robot service provider to coordinate the priority between the delivery robot 11 and the other delivery robot.

The delivery robot service provider 17 may transform a particular coordinate system (e.g., a cartesian coordinate system) into another coordinate system (e.g., a spherical coordinate system). The delivery robot service provider 17 may identify the current location of the delivery robot 11 using an appropriate coordinate system. The delivery robot service provider 17 may use an appropriate coordinate system to assist with an operation (e.g., the loading and unloading of the goods or the access to the urban infrastructure 19) of the delivery robot 11. The delivery robot service provider 17 may use an appropriate coordinate system to exchange information with the other delivery robot service provider.

The urban infrastructure 19 may include facilities (e.g., elevators, gates, common entrances, or electric charging stations) that need to be used, accessed, and/or passed by the delivery robot 11 to deliver the goods. The urban infrastructure 19 herein may be a device (e.g., a server) that manages the urban infrastructure 19. The urban infrastructure 19 may directly interwork with the delivery robot 11 and the delivery robot service provider 17.

The urban infrastructure 19 may share the information (e.g., the identifiers, the capacities, or the locations) regarding the urban infrastructure 19 with the delivery robot service provider 17.

The urban infrastructure 19 may notify the delivery robot service provider 17 whether the access of the delivery robot 11 is approved.

The urban infrastructure 19 may request the delivery robot service provider 17 to transmit information regarding the goods loaded on the delivery robot 11.

The urban infrastructure 19 may directly interwork with the delivery robot service provider 17. The urban infrastructure 19 may interwork with the delivery robot service provider 17 through another system (e.g., a building management system or an external infrastructure management service system).

The urban infrastructure 19 may directly interwork with the delivery robot 11 near the urban infrastructure 19.

The urban infrastructure 19 may provide the delivery robot service provider 17 with the information (e.g., service status, availability, breakdown, or inspection) regarding the urban infrastructure 19 in response to a request from the delivery robot service provider 17.

The delivery robot service system 10 may include data security means (e.g., communication encryption) for interworking.

The delivery robot service system 10 may include means to prevent data forgery for interworking.

The delivery robot service system 10 may include means to prevent leakage of the personal information of the user and the location information of the user.

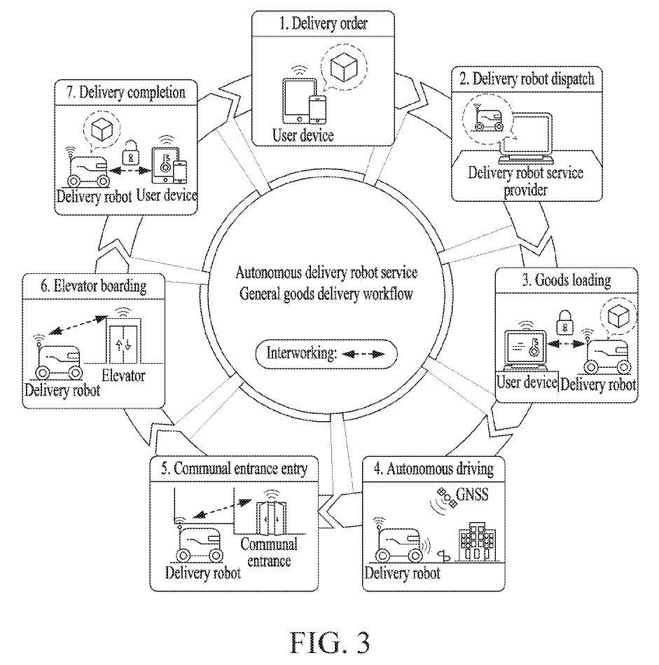

FIG. 3 is a schematic flowchart illustrating a workflow of a delivery robot service according to an embodiment.

Referring to FIG. 3, according to an embodiment, a user device (e.g., the user device 13 of FIG. 1) may transmit a delivery request from a user to a delivery robot service provider (e.g., the delivery robot service provider 17 of FIG. 1).

The delivery robot service provider 17 may confirm the delivery request and may assign a delivery robot (e.g., the delivery robot 11 of FIG. 1) in charge of delivery.

The delivery robot 11 may move to a pick-up location of goods through autonomous driving. The delivery robot 11 may interwork with the user device 13 to load the goods.

The delivery robot 11 may move to a destination (e.g., a delivery location) together with the loaded goods through autonomous driving.

The delivery robot 11 may interwork with urban infrastructure (e.g., the urban infrastructure 19 of FIG. 1) located on a delivery route. For example, the delivery robot 11 may communicate with the management systems (e.g., servers) of common entrances and elevators to use the common entrances and the elevators.

After arriving at the destination, the delivery robot 11 may unload the goods. To unload the goods, the delivery robot 11 may interwork with the user device 13.

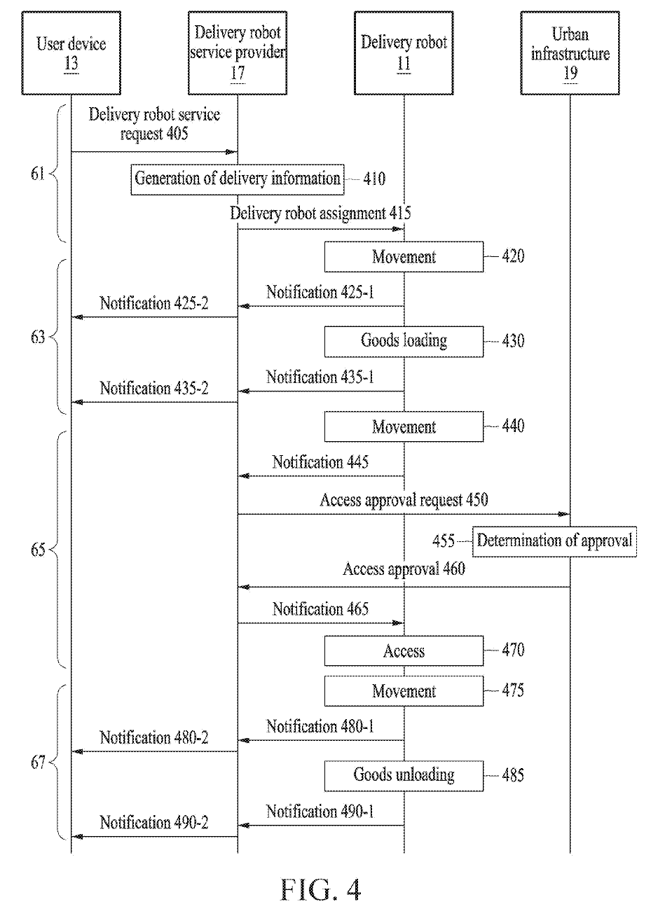

FIG. 4 is a flowchart illustrating the delivery robot service system according to an embodiment.

Referring to FIG. 4, according to an embodiment, a delivery process may include a delivery request phase 61, a loading phase 63, an infrastructure access phase 65, and an unloading phase 67. However, the infrastructure access phase 65 may be omitted depending on a delivery route or may be added between the delivery request phase 61 and the loading phase 63. Operations 405 to 490-2 may be performed sequentially, but examples are not limited thereto. For example, one or more operations may be omitted or added, or two or more operations may be performed in parallel.

In operation 405, the user device 13 (e.g., a device of a delivery requester) may transmit a delivery request to the delivery robot service provider 17. The delivery robot service provider 17 may receive the delivery request and may determine whether there is an available delivery robot. The delivery robot service provider 17 may transmit delivery request approval to the user device 13 when there is an available delivery robot (e.g., the delivery robot 11).

In operation 410, the delivery robot service provider 17 may generate delivery information regarding the approved delivery request. The delivery information may include at least one of a pick-up location, a delivery location, a delivery time, information (e.g., a location or an identifier) regarding infrastructure that needs to interwork with a delivery robot, a delivery route, the type of goods, the weight of the goods, the size of the goods, and a delivery condition (e.g., an appropriate temperature).

In operation 415, the delivery robot service provider 17 may assign the delivery robot 11 to perform the approved delivery request.

In operation 420, the delivery robot 11 may move to a pick-up location of goods through autonomous driving.

In operation 425-1, the delivery robot 11 may notify the delivery robot service provider 17 that the delivery robot 11 is waiting to load the goods after arriving at the pick-up location.

In operation 425-2, the delivery robot service provider 17 may notify the user device 13 (e.g., a robot or a device of a person who manages the loading) that the delivery robot 11 is waiting for the loading of the goods.

In operation 430, the delivery robot 11 may load the goods.

In operation 435-1, the delivery robot 11 may notify the delivery robot service provider 17 that the loading of the goods is completed.

In operation 435-2, the delivery robot service provider 17 may notify the user device 13 that the loading of the goods is completed.

In operation 440, the delivery robot 11 may move to a delivery location (e.g., a destination) through autonomous driving.

In operation 445, the delivery robot 11 may notify the delivery robot service provider 17 that the delivery robot 11 is waiting to access the urban infrastructure 19 when the delivery robot 11 arrives at the urban infrastructure 19 located on the delivery route.

In operation 450, the delivery robot service provider 17 may transmit an access approval request to the urban infrastructure 19.

In operation 455, the urban infrastructure 19 may determine whether to approve access.

In operation 460, the urban infrastructure 19 may notify the delivery robot service provider 17 that the access is approved.

In operation 465, the delivery robot service provider 17 may notify the delivery robot 11 that the access is approved.

In operation 470, the delivery robot 11 may access the urban infrastructure 19. For example, the delivery robot 11 may board an elevator or pass a common entrance.

In operation 475, the delivery robot 11 may move to the delivery location (e.g., the destination) through autonomous driving.

In operation 480-1, the delivery robot 11 may notify the delivery robot service provider 17 that the delivery robot 11 is waiting to unload the goods after the delivery robot 11 arrives at the delivery location.

In operation 480-2, the delivery robot service provider 17 may notify the user device 13 (e.g., a robot or a device of a recipient) that the delivery robot 11 is waiting for the unloading of the goods.

In operation 485, the delivery robot 11 may unload the goods.

In operation 490-1, the delivery robot 11 may notify the delivery robot service provider 17 that the unloading of the goods is completed.

In operation 490-2, the delivery robot service provider 17 may notify the user device 13 that the unloading of the goods is completed.

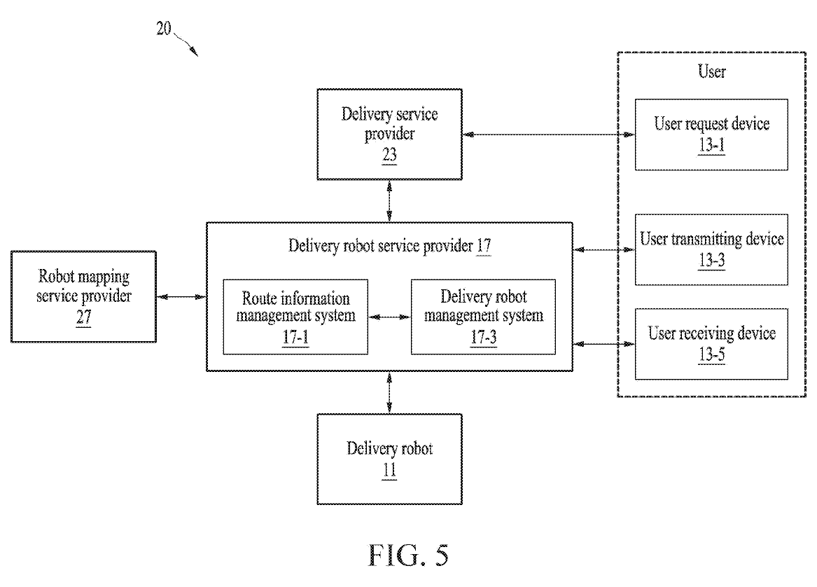

FIG. 5 is a diagram illustrating a delivery robot service system according to an embodiment.

Referring to FIG. 5, according to an embodiment, a delivery robot service system 20 may provide an unmanned delivery service using an autonomous mobile robot (e.g., the delivery robot 11) that performs loading/unloading of goods along a predetermined route based on delivery information requested by a user. The delivery robot service system 20 may include the delivery robot 11, user devices 13-1, 13-3, and 13-5, the delivery robot service provider 17, a delivery service provider 23, and a robot mapping service provider 27.

The delivery service provider 23 may provide a delivery service for delivering goods. The delivery service provider 23 may manage a goods delivery request for a user who requests a service (e.g., a goods delivery service) for delivering goods such that the user may use the delivery service. The delivery service provider 23 may generate delivery information and transmit delivery completion information to manage the goods delivery request. The delivery service provider 23 may be implemented as a server (e.g., a server device).

The delivery service provider 23 may receive a delivery request (e.g., the user's delivery request) from the user request device 13-1. The delivery service provider 23 may generate delivery information for the delivery request and transmit the generated delivery information to the delivery robot service provider 17. The delivery information may include at least one of a pick-up location, a delivery location, a delivery time, information regarding one or more pieces of infrastructure (e.g., the urban infrastructure 19) that need to interwork with the delivery robot 11, a delivery route, a type of goods, a weight of goods, a size of goods, and a delivery condition (e.g., an appropriate temperature). The one or more pieces of infrastructure may be located along the delivery route.

The delivery robot service provider 17 may operate and manage the delivery robot 11 and may generate and manage route information for goods delivery and charging of the delivery robot 11. The delivery robot service provider 17 may include a route information management system 17-1 for managing route information and a delivery robot management system 17-3 for managing the delivery robot 11. The delivery robot management system 17-3 may assign the delivery robot 11 to deliver goods based on the delivery information. The delivery robot management system 17-3 may notify a user device (e.g., the user transmitting device 13-3 or the user receiving device 13-5) that the delivery robot 11 is waiting to load/unload goods and may notify the delivery robot 11 that the loading/unloading of the goods has been completed. The route information management system 17-1 may generate route information for goods delivery based on the delivery information. The route information management system 17-1 may generate route information using robot map information obtained from the robot mapping service provider 27 and the delivery information.

The robot mapping service provider 27 may generate and provide robot map information (e.g., map and spatial object information) for the delivery robot 11.

The delivery robot 11 may move to a pick-up location/delivery location (e.g., a destination) of the goods through autonomous driving based on route information. The delivery robot 11 may be a device related to loading goods and/or a device related to unloading goods.

The user request device 13-1 may be a device of a delivery requester. Based on input from the user (e.g., the delivery requester), the user request device 13-1 may transmit a delivery request for delivering goods to the delivery service provider 23.

The user transmitting device 13-3 may be a device related to loading goods. The user transmitting device 13-3 may receive information (e.g., loading request information) from the delivery robot service provider 17 indicating that the delivery robot 11 is waiting for the loading of the goods. An object (e.g., a person or another robot) located at the pick-up location may load the goods on the delivery robot 11. After an object located at the pick-up location loads goods to the delivery robot 11, the user transmitting device 13-3 may transmit, to the delivery robot service provider 17, information (e.g., loading completion information) indicating that the loading of the goods has been completed.

The user receiving device 13-5 may be a device related to unloading goods. The user receiving device 13-5 may receive information (e.g., unloading request information) from the delivery robot service provider 17 indicating that the delivery robot 11 is waiting for the unloading of the goods. An object (e.g., a person or another robot) located at the delivery location may unload the goods from the delivery robot 11. After an object located at the delivery location unloads goods from the delivery robot 11, the user receiving device 13-5 may transmit, to the delivery robot service provider 17, information (e.g., unloading completion information) indicating that the unloading of the goods has been completed.

The user request device 13-1, the user transmitting device 13-3, and the user receiving device 13-5 may be different devices or two or more of them may be the same device. For example, the user request device 13-1, the user transmitting device 13-3, and the user receiving device 13-5 may each be a device of a different user. In another example, the user request device 13-1 and the user transmitting device 13-3 may be the same device of the same user, while the user receiving device 13-5 may be a device of a different user. In another example, the user request device 13-1 and the user receiving device 13-5 may be the same device of the same user, while the user transmitting device 13-3 may be a device of a different user.

The operations of the delivery robot 11, the user devices 13-1, 13-3, and 13-5, and/or the delivery robot service provider 17 are substantially the same as those described with reference to FIGS. 1 to 4, and repeated description thereof is omitted.

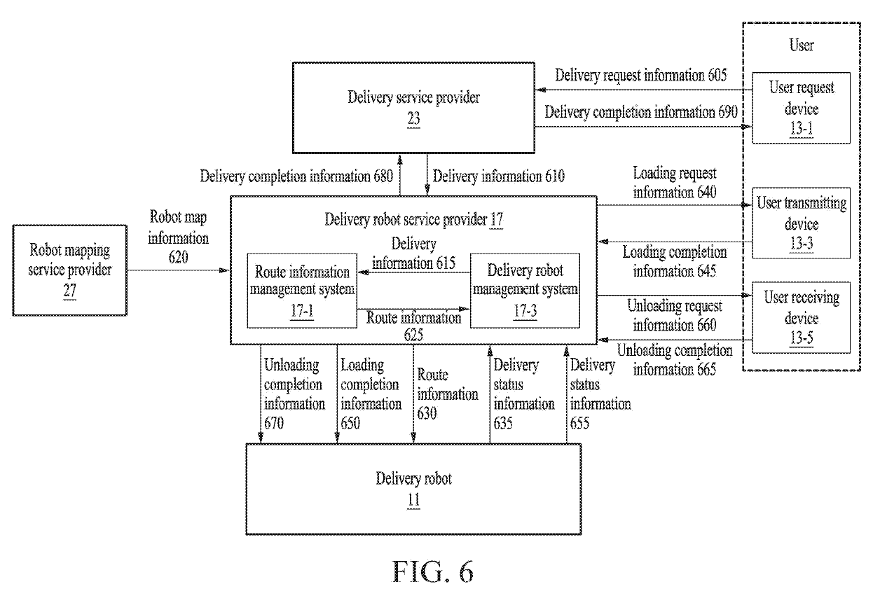

FIG. 6 is a diagram illustrating a delivery method based on an autonomous mobile robot according to an embodiment.

Referring to FIG. 6, according to an embodiment, operations 605 to 690 may be performed sequentially, but the embodiment is not limited thereto. For example, one or more operations may be omitted or added, or two or more operations may be performed in parallel.

In operation 605, the user request device 13-1 may request delivery of goods to the delivery service provider 23. The user request device 13-1 may generate delivery request information for requesting delivery of goods and may transmit the delivery request information to the delivery service provider 23. The delivery request information may include N loadings (e.g., N is a natural number greater than 1) and/or M unloadings (e.g., M is a natural number greater than 1). N may represent the number of pick-up locations, and M may represent the number of delivery locations.

In operation 610, the delivery service provider 23 may generate delivery information based on the delivery request information and may transmit the delivery information to the delivery robot management system 17-3 included in the delivery robot service provider 17. The delivery information may include at least one of N pick-up locations, M delivery locations, a delivery time, information regarding one or more pieces of infrastructure (e.g., the urban infrastructure 19) that need to interwork with the delivery robot 11, a delivery route, a type of goods, a weight of goods, a size of goods, and a delivery condition (e.g., an appropriate temperature). The one or more pieces of infrastructure may be located along the delivery route.

In operation 615, the delivery robot management system 17-3 may identify and/or assign the delivery robot 11 (e.g., a delivery robot available for delivery) to perform the delivery request based on the delivery information, may extract (or derive) a pick-up/delivery location (e.g., pick-up/delivery location information) from the delivery information, and may request route information including the pick-up/delivery location from the route information management system 17-1 included in the delivery robot service provider 17. The delivery robot management system 17-3 may transmit the delivery information to the route information management system 17-1 while requesting the route information.

In operation 620, the route information management system 17-1 may obtain robot map information from the robot mapping service provider 27. The robot map information may include the latest robot map information stored (or retained) in a robot map database (not shown) included in the robot mapping service provider 27. The route information management system 17-1 may request robot map information from the robot mapping service provider 27, and the robot mapping service provider 27 may transmit robot map information (e.g., the latest robot map information) to the route information management system 17-1 in response to the request from the route information management system 17-1. In addition, the route information management system 17-1 may obtain (e.g., receive) robot map information from the robot mapping service provider 27 in advance. The route information management system 17-1 may receive robot map information that is continuously updated from the robot mapping service provider 27.

In operation 625, the route information management system 17-1 may generate: route information regarding an optimal route between a pick-up location and a delivery location based on the pick-up/delivery location; and robot map information included in the delivery information and may transmit the route information to the delivery robot management system 17-3. When the delivery information includes N pick-up locations and M delivery locations, the route information management system 17-1 may determine different loading and unloading orders according to the route information.

In operation 630, the delivery robot management system 17-3 may transmit route information to the delivery robot 11 that is to deliver goods.

In operation 635, the delivery robot 11 may generate delivery status information (e.g., a current location of the delivery robot 11, status information of the delivery robot 11, a goods loading status, a type of goods, or a status of goods) and may transmit the delivery status information to the delivery robot management system 17-3. For example, the delivery robot 11 may move to the pick-up location based on the route information. The delivery robot 11 may generate delivery status information while moving to the pick-up location and may transmit the delivery status information to the delivery robot management system 17-3. In operation 635, the delivery status information may be first delivery status information.

In operation 640, the delivery robot management system 17-3 may determine whether the delivery robot 11 has arrived at the pick-up location based on the delivery status information. The delivery robot management system 17-3 may transmit loading request information to the user transmitting device 13-3 when the delivery robot 11 arrives at the pick-up location. The user transmitting device 13-3 may be informed through the loading request information that the delivery robot 11 is waiting to load the goods.

In operation 645, an object (e.g., a human or another robot) located at the pick-up location may check the loading request information through the user transmitting device 13-3 and may load the goods on the delivery robot 11 using the loading request information. The delivery robot 11 may also load the goods. After an object located at the pick-up location loads the goods onto the delivery robot 11, the user transmitting device 13-3 and/or the delivery robot 11 may transmit, to the delivery robot management system 17-3, information (e.g., loading completion information) indicating that the loading of the goods has been completed.

In operation 650, the delivery robot management system 17-3 may transmit the loading completion information to the delivery robot 11. When the delivery robot 11 transmits loading completion information to the delivery robot management system 17-3, the delivery robot management system 17-3 may transmit the loading completion information to the user transmitting device 13-3 to notify that the loading of the goods has been completed.

In operation 655, after receiving the loading completion information, the delivery robot 11 may move to the delivery location through autonomous driving based on the route information. The delivery robot 11 may generate delivery status information (e.g., a current location of the delivery robot 11, status information of the delivery robot 11, a goods loading status, a type of goods, or a status of goods) while moving to the delivery location and may transmit the delivery status information to the delivery robot management system 17-3. In operation 655, the delivery status information may be second delivery status information.

In operation 660, the delivery robot management system 17-3 may determine whether the delivery robot 11 has arrived at the delivery location based on the delivery status information. The delivery robot management system 17-3 may transmit unloading request information to the user receiving device 13-5 when the delivery robot 11 arrives at the delivery location. The user receiving device 13-5 may be informed through the unloading request information that the delivery robot 11 is waiting to unload the goods.

In operation 665, an object (e.g., a human or another robot) located at the delivery location may check the unloading request information through the user receiving device 13-5 and may unload the goods from the delivery robot 11 using the unloading request information. The delivery robot 11 may also unload the goods. After an object located at the delivery location unloads the goods from the delivery robot 11, the user receiving device 13-5 and/or the delivery robot 11 may transmit, to the delivery robot management system 17-3, information (e.g., delivery completion information) indicating that the unloading of the goods has been completed.

In operation 670, the delivery robot management system 17-3 may transmit the delivery completion information to the delivery robot 11. When the delivery robot 11 transmits delivery completion information to the delivery robot management system 17-3, the delivery robot management system 17-3 may transmit the delivery completion information to the user receiving device 13-5 to notify that the unloading of the goods has been completed.

In operation 680, the delivery robot management system 17-3 may generate delivery completion information based on the unloading completion information and may transmit the delivery completion information to the delivery service provider 23.

In operation 690, the delivery service provider 23 may transmit delivery completion information to the user request device 13-1.

For example, when the delivery request information includes N loadings, operations 635 to 650 may be performed N times. The goods may be loaded onto the delivery robot 11 at each of the N pick-up locations.

In another example, when the delivery request information includes M unloadings, operations 655 to 670 may be performed M times. The goods may be unloaded from the delivery robot 11 at each of the M delivery locations.

In another example, when the delivery request information includes N loadings and M unloadings, the delivery robot 11 may perform delivery in the order of loading and unloading based on the route information. For example, when a user orders coffee, bottled water, and digestive medicine from 1) a café, 2) a convenience store, and 3) a pharmacy, respectively, and requests that the coffee be delivered to 4) a company and the bottled water and digestive medicine be delivered to 5) a home, the route information generated (or calculated) by the delivery robot service provider 17 may be generated as loading 1 (e.g., coffee@café) → loading 2 (e.g., bottled water@convenience store) → unloading 1 (e.g., coffee@company) → loading 3 (e.g., digestive medicine@pharmacy) → unloading 2 (e.g., bottled water, digestive medicine@home). The delivery robot 11 may perform three loadings and two unloadings based on the route information. When the delivery request information includes N loadings and M unloadings, the loading and unloading order may vary depending on the route information.

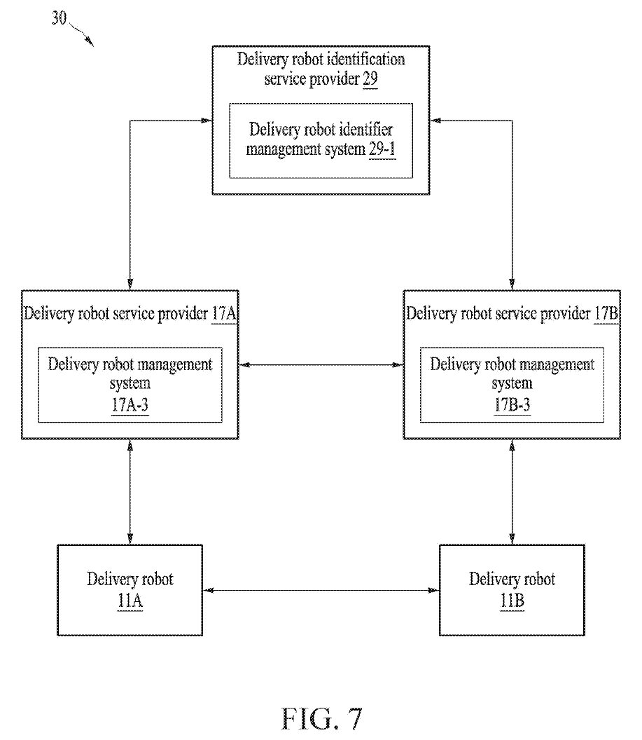

FIG. 7 is a diagram illustrating a delivery robot service system according to an embodiment.

Referring to FIG. 7, according to an embodiment, a delivery robot service system 30 may include delivery robots 11A and 11B, delivery robot service providers 17A and 17B, and a delivery robot identification service provider 29. The operations of the components (e.g., the delivery robots 11A and 11B, the delivery robot service providers 17A and 17B, and the robot mapping service provider 27) in the delivery robot service system 30 are substantially the same as those described with reference to FIGS. 1 to 6, and thus a detailed description thereof is omitted.

The delivery robot service provider 17A may receive delivery information transmitted from a delivery service provider (e.g., the delivery service provider 23 of FIG. 5) providing a delivery service for goods. The delivery service provider 23 may generate delivery information for a delivery request (e.g., a user's delivery request) and transmit the delivery information to the delivery robot service provider 17A.

The delivery robot service provider 17A may generate delivery information for a delivery request (e.g., a user's delivery request). The delivery information may be delivery route information. The delivery information may include at least one of a pick-up location, a delivery location, a delivery time, information regarding one or more pieces of infrastructure (e.g., the infrastructure 19 of FIG. 1) that need to interwork with the delivery robot 11A (e.g., a location, an identifier, a communication scheme, and/or elevator function information), a delivery route, a type of goods, a weight of goods, a size of goods, and a delivery condition (e.g., an appropriate temperature).

The delivery robot service provider 17A may operate and manage the delivery robot 11A and may generate and manage route information for goods delivery and charging of the delivery robot 11A. The delivery robot service provider 17A may include a delivery robot management system 17A-3 for managing the delivery robot 11A.

The delivery robot 11A may be a delivery robot managed by the delivery robot service provider 17A. The delivery robot 11A may deliver goods based on delivery information transmitted from the delivery robot service provider 17A.

The delivery robot service provider 17B may receive delivery information transmitted from a delivery service provider (e.g., the delivery service provider 23 of FIG. 5) providing a delivery service for goods. The delivery service provider 23 may generate delivery information for a delivery request (e.g., a user's delivery request) and transmit the delivery information to the delivery robot service provider 17B. The delivery information received by the delivery robot service provider 17B may be different from, or the same as, the delivery information received by the delivery robot service provider 17A.

The delivery robot service provider 17B may generate delivery information for a delivery request (e.g., a user's delivery request). The delivery information may be delivery route information. The delivery information may include at least one of a pick-up location, a delivery location, a delivery time, information regarding one or more pieces of infrastructure (e.g., the infrastructure 19 of FIG. 1) that need to interwork with the delivery robot 11B (e.g., a location, an identifier, a communication scheme, and/or elevator function information), a delivery route, a type of goods, a weight of goods, a size of goods, and a delivery condition (e.g., an appropriate temperature).

The delivery robot service provider 17B may operate and manage the delivery robot 11B and may generate and manage route information for goods delivery and charging of the delivery robot 11B. The delivery robot service provider 17B may include a delivery robot management system 17B-3 for managing the delivery robot 11B.

The delivery robot 11B may be a delivery robot managed by the delivery robot service provider 17B. The delivery robot 11B may deliver goods based on delivery information transmitted from the delivery robot service provider 17B.

The delivery robot 11A and the delivery robot 11B may meet in infrastructure (e.g., a space or facility such as an elevator or a common entrance) that they commonly use on their delivery routes.

In an embodiment, the delivery robot 11A and the delivery robot 11B may meet and cooperate with each other in commonly used infrastructure. For example, the delivery robot 11A and the delivery robot 11B may perform loading and unloading operations for moving goods in the commonly used infrastructure.

In an embodiment, the delivery robot 11A and the delivery robot 11B may compete to use the commonly used infrastructure. For example, the delivery robot 11A and the delivery robot 11B may coordinate priorities for using infrastructure (e.g., boarding an elevator) in the commonly used infrastructure.

The delivery robot identification service provider 29 may allow information to be exchanged between delivery robot service providers such that delivery robots may cooperate and/or compete to use infrastructure. To exchange information between delivery robot service providers, the delivery robot identification service provider 29 may register an identifier of a delivery robot managed by a delivery robot service provider by matching the identifier to information of the delivery robot service provider. For example, the delivery robot identification service provider 29 may register an identifier of the delivery robot 11A by matching the identifier to information of the delivery robot service provider 17A and may register an identifier of the delivery robot 11B by matching the identifier to information of the delivery robot service provider 17B.

The delivery robot identification service provider 29 may allow information to be exchanged between the delivery robot service provider 17A and the delivery robot service provider 17B. The delivery robot service provider 17A and the delivery robot service provider 17B may perform competition and/or cooperation between the delivery robot 11A and the delivery robot 11B based on the exchanged information.

When delivery robots (e.g., the delivery robot 11A and the delivery robot 11B) meet each other in infrastructure, the delivery robots may exchange their identifiers (or identifier information) registered by the delivery robot identification service provider 29. The delivery robot 11A may transmit the identifier of the delivery robot 11A to the delivery robot 11B, and the delivery robot 11B may transmit the identifier of the delivery robot 11B to the delivery robot 11A.

The delivery robot management system 17A-3 of the delivery robot service provider 17A may receive the identifier of the delivery robot 11B from the delivery robot 11A. A delivery robot identifier management system 29-1 of the delivery robot identification service provider 29 may receive the identifier of the delivery robot 11B from the delivery robot management system 17A-3 of the delivery robot service provider 17A. The delivery robot identifier management system 29-1 may transmit information (e.g., information for communicating (or connecting) with the delivery robot service provider 17B) of the delivery robot service provider 17B that manages the delivery robot 11B to the delivery robot management system 17A-3 in response to the identifier of the delivery robot 11B, received from the delivery robot management system 17A-3.

The delivery robot management system 17B-3 of the delivery robot service provider 17B may receive the identifier of the delivery robot 11A from the delivery robot 11B. The delivery robot identifier management system 29-1 of the delivery robot identification service provider 29 may receive the identifier of the delivery robot 11A from the delivery robot management system 17B-3 of the delivery robot service provider 17B. The delivery robot identifier management system 29-1 may transmit information (e.g., information for communicating (or connecting) with the delivery robot service provider 17A) of the delivery robot service provider 17A that manages the delivery robot 11A to the delivery robot management system 17B-3 in response to the identifier of the delivery robot 11A, received from the delivery robot management system 17B-3.

When an identifier of a delivery robot is spoofed by a malicious third party, unnecessary disclosure of sensitive information of a delivery robot service provider may occur. For example, after another delivery robot (not shown) using the identifier of the delivery robot 11B exchanges identifiers with the delivery robot 11A, another delivery robot service provider (not shown), other than the delivery robot service provider 17B that received the identifier of the delivery robot 11A, may attempt to exchange information with the delivery robot service provider 17A. To prevent damage caused by identity spoofing, such as unnecessary disclosure of sensitive information, a process may be needed to verify whether an identifier of a delivery robot registered by the delivery robot identification service provider 29 has been spoofed.

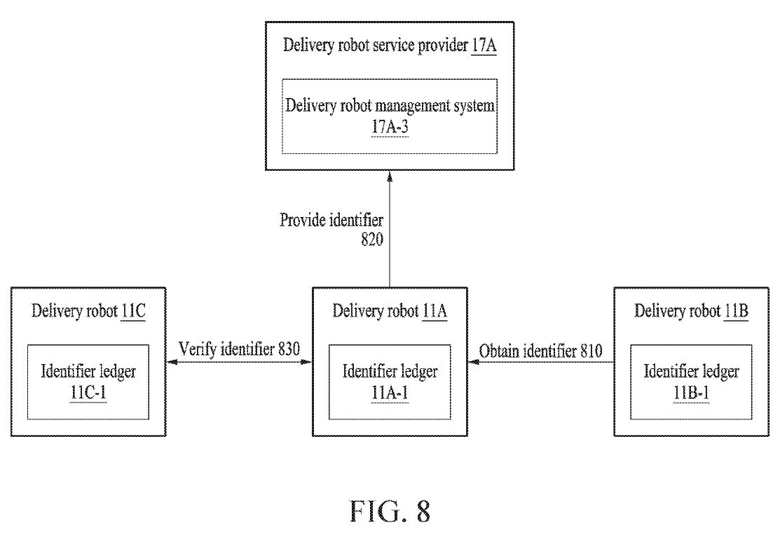

FIG. 8 is a flowchart illustrating a method of verifying the reliability of identifiers among a plurality of delivery robots according to an embodiment.

Referring to FIG. 8, according to an embodiment, operations 810 to 830 may be performed sequentially but are not limited thereto. For example, one or more operations may be omitted or added, or two or more operations may be performed in parallel.

The delivery robot service system 30 described with reference to FIG. 7 may further include a delivery robot 11C and a delivery robot service provider (not shown) that manages the delivery robot 11C. The operation of the delivery robot 11C and the delivery robot service provider (not shown) that manages the delivery robot 11C is substantially the same as that described with reference to FIGS. 1 to 7, and a detailed description thereof is omitted.

Each of the delivery robots 11A, 11B, and 11C may include an identifier document. The identifier document may include, for example, an identifier, identifier ledgers 11A-1, 11B-1, and 11C-1, a public key, and a private key. The identifier documents of the delivery robots 11A, 11B, and 11C may form a blockchain network. The identifier document may be assigned by a delivery robot identification service provider (e.g., the delivery robot identification service provider 29 of FIG. 7) and a delivery robot service provider. For example, the identifier document of the delivery robot 11A may be assigned by the delivery robot identification service provider (e.g., the delivery robot identification service provider 29 of FIG. 7) and the delivery robot service provider 17A.

The delivery robots 11A, 11B, and 11C may use their identifier documents to verify the reliability of identifiers of delivery robots that they meet. Verifying the reliability of an identifier may refer to verifying the reliability of a delivery robot that uses the identifier. The delivery robots 11A, 11B, and 11C may use the identifier ledgers 11A-1, 11B-1, and 11C-1 to verify identifiers of other delivery robots and to determine and/or adjust the reliability of the other delivery robots. An identifier ledger may be a ledger that registers identifiers of delivery robots that a delivery robot meets. For example, the identifier ledger 11A-1 of the delivery robot 11A may be a ledger that registers identifiers of delivery robots that the delivery robot 11A meets.

In an embodiment, the identifier documents of the delivery robots 11A, 11B, and 11C may include a reliability list for managing reliability corresponding to identifiers registered in the identifier ledgers 11A-1, 11B-1, and 11C-1. In an embodiment, the delivery robots 11A, 11B, and 11C may register their reliability together with their identifiers in the identifier ledgers 11A-1, 11B-1, and 11C-1.

In operation 810, the delivery robot 11A may obtain an identifier from the delivery robot 11B. When the delivery robot 11A meets the delivery robot 11B in infrastructure commonly used by the delivery robot 11A, the delivery robot 11A and the delivery robot 11B may exchange identifiers. The delivery robot 11A may receive the identifier of the delivery robot 11B from the delivery robot 11B. The delivery robot 11B may receive the identifier of the delivery robot 11A from the delivery robot 11A.

In an embodiment, when the delivery robot 11A meets the delivery robot 11B in commonly used infrastructure, the delivery robot 11A and the delivery robot 11B may exchange public keys. For example, the delivery robot 11A may receive the public key of the delivery robot 11B from the delivery robot 11B. For example, the delivery robot 11B may receive the public key of the delivery robot 11A from the delivery robot 11A.

When the delivery robot 11A and the delivery robot 11B exchange public keys, verification of the public keys using a private key may be performed. For example, the delivery robot 11A may request a signature from the delivery robot 11B while providing unique data. The delivery robot 11B may generate a digital signature using the private key of the delivery robot 11B. The delivery robot 11A may receive a digital signature corresponding to the unique data. The delivery robot 11A may verify the public key of the delivery robot 11B by verifying the digital signature using the public key. Verification enables determination that the public keys exchanged between delivery robots have not been spoofed.

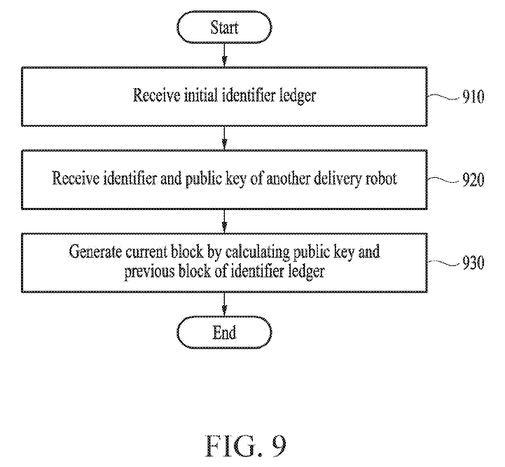

When the delivery robots 11A and 11B first meet each other, they may register their identifiers in the identifier ledgers 11A-1 and 11B-1. For example, the delivery robot 11A may register the identifier of the delivery robot 11B in the identifier ledger 11A-1. In an embodiment, the delivery robots 11A and 11B may register their identifiers in the identifier ledgers 11A-1 and 11B-1 using each other's public keys. For example, the delivery robot 11A may register the identifier of the delivery robot 11B in the identifier ledger 11A-1 using the public key of the delivery robot 11B. The registration of an identifier using a public key is described below with reference to FIG. 9.

In operation 820, the delivery robot 11A may provide the identifier of the delivery robot 11B to the delivery robot service provider 17A. The delivery robot management system 17A-3 may perform competition and/or cooperation between the delivery robot 11A and the delivery robot 11B using the identifier of the delivery robot 11B, received from the delivery robot 11A.

In an embodiment, prior to operation 810, the delivery robot 11A may determine that the delivery robot 11B is an unreliable delivery robot. The delivery robot 11A may determine that the delivery robot 11B is not a reliable delivery robot when the reliability of the delivery robot 11B, registered in the identifier document of the delivery robot 11A ,is less than a threshold reliability. The reliability of the delivery robot 11B may initially be greater than the threshold reliability.

After the delivery robot 11B is determined to be an unreliable delivery robot, when the delivery robot 11A obtains the identifier of the delivery robot 11B, the delivery robot 11A may transmit, together with the identifier of the delivery robot 11B, information indicating that the delivery robot 11B is an unreliable delivery robot to the delivery robot service provider 17A. In an embodiment, when the delivery robot management system 17A-3 receives information that the delivery robot 11B is an unreliable delivery robot, the delivery robot management system 17A-3 may not perform competition and/or cooperation between the delivery robot 11A and the delivery robot 11B and may not perform information exchange for performing the competition and/or cooperation.

In operation 830, the delivery robot 11A and the delivery robot 11C may verify the identifier of the delivery robot 11B. When the delivery robot 11A meets the delivery robot 11C in infrastructure that is commonly used by the delivery robot 11A, the delivery robot 11A and the delivery robot 11C may verify the identifier of the delivery robot 11B. The identifier ledger 11C-1 may include the identifier of the delivery robot 11B. The delivery robot 11C may be a delivery robot that has already registered the identifier of the delivery robot 11B in the identifier ledger 11C-1. The delivery robot 11C may be a delivery robot that is registered in the identifier ledger 11A-1 of the delivery robot 11A and that is reliable to the delivery robot 11A.

The delivery robot 11C is registered in the identifier ledger 11A-1 of the delivery robot 11A and may be a delivery robot that is reliable to the delivery robot 11A. For example, the delivery robot 11A may transmit the identifier of the delivery robot 11B to the delivery robot 11C, and the delivery robot 11C may transmit the identifier of the delivery robot 11B to the delivery robot 11A. The delivery robots 11A and 11C may determine duplicate identifiers among the identifiers registered in the identifier ledgers 11A-1 and 11C-1. For example, the delivery robots 11A and 11C may determine the identifier of the delivery robot 11B that is registered in duplicate in the identifier ledgers 11A-1 and 11C-1.

The delivery robots 11A and 11C may generate public keys corresponding to identifiers that are determined to be duplicate. Based on blocks of the identifier ledgers 11A-1 and 11C-1, the delivery robots 11A and 11C may generate public keys corresponding to identifiers determined to be duplicated. For example, based on blocks of the identifier ledger 11A-1, the delivery robot 11A may generate a first public key corresponding to the identifier of the delivery robot 11B. For example, based on blocks of the identifier ledger 11C-1, the delivery robot 11C may generate a second public key corresponding to the identifier of the delivery robot 11B.

The delivery robots 11A and 11C may verify whether the public keys corresponding to the identifiers are the same. For example, the delivery robots 11A and 11C may verify whether the first public key generated by the delivery robot 11A in response to the identifier of the delivery robot 11B and the second public key generated by the delivery robot 11C in response to the identifier of the delivery robot 11B are the same. When the public keys are not the same, the delivery robot 11B that the delivery robot 11A meets may be spoofing the identifier.

The delivery robots 11A and 11C may determine the reliability of the delivery robot 11B based on the verification. The delivery robots 11A and 11C may increase the reliability of the delivery robot 11B when the public keys corresponding to the same identifier are the same. The delivery robots 11A and 11C may decrease the reliability of the delivery robot 11B when the public keys corresponding to the same identifier are not the same.

Whenever the delivery robot 11A meets other delivery robots within infrastructure that have identifiers registered in an identifier ledger, the delivery robot 11A may perform identifier verification and adjust the reliability of the delivery robot 11B. When the identifier document of the delivery robot 11A includes a reliability list, the delivery robot 11A may adjust the reliability corresponding to the identifier of the delivery robot 11B in the reliability list. When the reliability of the delivery robot 11B is registered in the identifier ledger 11A-1 of the delivery robot 11A, the delivery robot 11A may register the adjusted reliability of the delivery robot 11B in the identifier ledger 11A-1. The more reliable delivery robots that may be met by the delivery robot 11A in infrastructure, the more effectively the delivery robot 11A may adjust the reliability of the delivery robot 11B.

The delivery robot 11A may compare the reliability of the delivery robot 11B with a predetermined threshold reliability. The delivery robots 11A, 11B, and 11C may determine that other delivery robots with a reliability less than the threshold reliability are unreliable delivery robots. A delivery robot may determine that the delivery robot 11B is an unreliable delivery robot when the reliability of the delivery robot 11B is adjusted to be less than the threshold reliability. The delivery robot 11A may not perform identifier verification with unreliable delivery robots.

FIG. 9 is a flowchart illustrating a method of registering an identifier in an identifier ledger according to an embodiment.

According to an example, operations 910 to 930 may be performed sequentially but are not limited thereto. For example, one or more operations may be omitted or added, or two or more operations may be performed in parallel.

In operation 910, the delivery robot 11 may receive an initial identifier ledger from the delivery robot identification service provider 29 and the delivery robot service provider 17. The initial identifier ledger may include identifiers of delivery robots that the delivery robot 11 is likely to meet.

In operation 920, the delivery robot 11 may receive an identifier and a public key of another delivery robot. When the delivery robot 11 meets another delivery robot in commonly used infrastructure, the delivery robot 11 may transmit a request to the other delivery robot to provide an identifier and a public key. The delivery robot 11 may perform verification of the received public key using a private key.

In operation 930, the delivery robot 11 may generate a current block by calculating a public key and a previous block of the identifier ledger. A plurality of blocks may include chained blocks. The previous block in the identifier ledger may represent the most recently registered block in the current identifier ledger.

The delivery robot 11 may generate the current block through a block generation operation between the public key received in operation 920 and the previous block of the identifier ledger. An identifier ledger may include a plurality of blocks. Each block in the identifier ledger may include an identifier of a delivery robot. In an embodiment, each block of the identifier ledger may include an identifier of a delivery robot and a corresponding reliability. A block generation operation may include an inverse operation. For example, the block generation operation may include, but is not limited to, an exclusive OR (XOR) operation. The current block may correspond to a block in which the identifier of the delivery robot, received in operation 920, is registered.

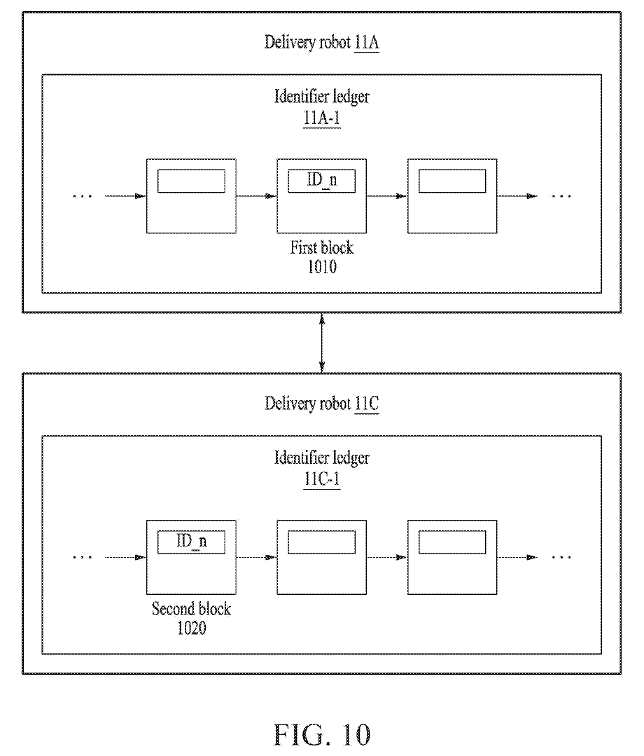

FIG. 10 is a diagram illustrating a method of verifying identifiers among a plurality of delivery robots according to an embodiment.

The delivery robot 11A may meet a delivery robot n in infrastructure and register an identifier ID_n of the delivery robot n in a first block 1010 of the identifier ledger 11A-1. The delivery robot 11C may meet the delivery robot n in infrastructure and register the identifier ID_n of the delivery robot n in a second block 1020 of the identifier ledger 11C-1. For example, the delivery robot n may be the delivery robot 11B.

The delivery robot n met by the delivery robot 11A and the delivery robot n met by the delivery robot 11C use the same identifier ID_n, but the delivery robot n met by the delivery robot 11A and the delivery robot n met by the delivery robot 11C may be different from each other.

To verify whether the delivery robot n met by the delivery robot 11A and the delivery robot n met by the delivery robot 11C are the same, the delivery robots 11A and 11C may verify whether the public keys of the delivery robot n are the same. The operation of comparing public keys may be referred to as block transition verification.

The delivery robot 11A may use the public key of the delivery robot n in the block generation operation that generates the first block 1010. The block generation operation may be an inverse operation. The delivery robot 11A may generate the public key of the delivery robot n through an inverse operation of the block generation operation between the first block 1010 and a previous block of the first block 1010.

The delivery robot 11C may use the public key of the delivery robot n in the block generation operation that generates the second block 1020. The block generation operation may be an inverse operation. The delivery robot 11C may generate the public key of the delivery robot n through an inverse operation of the block generation operation between the second block 1020 and a previous block of the second block 1020.

The delivery robots 11A and 11C may verify whether the public key generated by the delivery robot 11A and the public key generated by the delivery robot 11C are the same. When the public keys are not the same, one of the delivery robots that the delivery robot 11A and the delivery robot 11C meet as the delivery robot n may be spoofing the identifier ID_n. When the public keys are the same, the delivery robots 11A and 11C may increase the reliability of the delivery robot that uses the identifier ID_n. When the public keys are not the same, the delivery robots 11A and 11C may decrease the reliability of the delivery robot using the identifier ID_n.

In an embodiment, the first block 1010 and/or the second block 1020 may include an identifier ID_n of the delivery robot n and a reliability corresponding to the identifier ID_n. The delivery robots 11A and 11C may register a new block including the identifier ID_n and the adjusted reliability in the identifier ledgers 11A-1 and 11C-1 to increase or decrease the reliability corresponding to the identifier ID_n. The delivery robots 11A and 11C may use the newly registered blocks instead of the first block 1010 and the second block 1020 in a subsequent identifier verification process.

When the reliability of a delivery robot using the identifier ID_n is adjusted to be less than a threshold reliability, the delivery robots 11A and 11C may determine that the delivery robot using the identifier ID_n is an unreliable delivery robot. When the delivery robots 11A and 11C meet a delivery robot using the identifier ID_n again, the delivery robots 11A and 11C may transmit information to the delivery robot service providers 17A and 17C that the delivery robot using the identifier ID_n is an unreliable delivery robot, thereby preventing unnecessary disclosure of information.

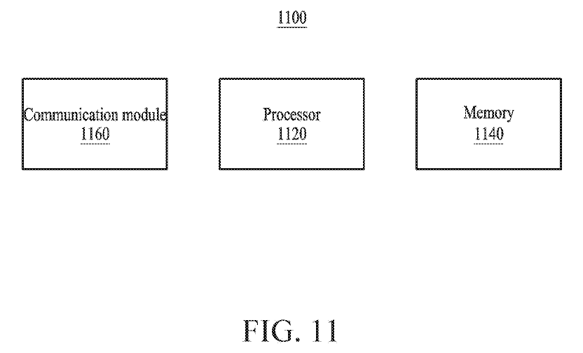

FIG. 11 is a schematic block diagram illustrating a delivery robot according to an embodiment.

Referring to FIG. 11, according to an embodiment, a delivery robot 1100 (e.g., the delivery robot 11 of FIGS. 1 to 10) may include a processor 1120, a memory 1140, and a communication module 1160. The delivery robot 1100 may be implemented as a delivery robot 11A and/or a delivery robot 11B.

The memory 1140 may store instructions (or programs) executable by the processor 1120. For example, the instructions include instructions for executing the operations of the processor 1120 and/or operations of each component of the processor 1120.

The memory 1140 may include one or more computer-readable storage media. The memory 1140 may include non-volatile storage elements (e.g., a magnetic hard disk, an optical disc, a floppy disc, flash memory, electrically programmable memory (EPROM), and electrically erasable and programmable memory (EEPROM)).

The memory 1140 may be a non-transitory medium. The term "non-transitory" may indicate that a storage medium is not embodied in a carrier wave or a propagated signal. However, the term "non-transitory" should not be interpreted to mean that the memory 1140 is non-movable.

The processor 1120 may process data stored in the memory 1140. The processor 1120 may execute computer-readable code (e.g., software) stored in the memory 1140 and instructions triggered by the processor 1120.

The processor 1120 may be a hardware-implemented data processing device with a physically structured circuit to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

The processor 1120 may cause the delivery robot 1100 to perform one or more operations by executing the code, instructions, and/or applications stored in the memory 1140. The operations performed by the delivery robot 1100 may be substantially the same as the operations performed by the delivery robot 11 described with reference to FIGS. 1 to 11. Accordingly, a repeated description thereof is omitted.

The communication module 1160 may establish a communication channel (e.g., a wireless communication channel) for communication. The communication module 1160 may support the communication through the established communication channel. The communication module 1160 may include one or more communication processors configured to support direct (or wired) communication or wireless communication. The communication module 1160 may include a wireless communication module (e.g., a cellular communication module, a short-range wireless communication module, or a global navigation satellite system (GNSS) communication module) or a wired communication module (e.g., a local area network (LAN) communication module, or a power line communication (PLC) module).

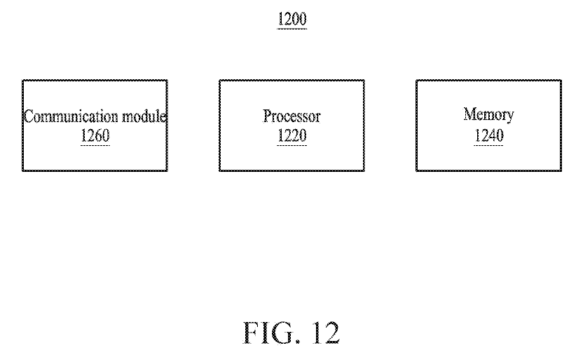

FIG. 12 is a schematic block diagram illustrating a delivery robot service provider according to an embodiment.

Referring to FIG. 12, according to an embodiment, a delivery robot service provider 1200 (e.g., the delivery robot service provider 17 of FIGS. 1 to 10) may include a processor 1220, a memory 1240, and a communication module 1260. The delivery robot service provider 1200 may be implemented as a delivery robot service provider 17A and/or a delivery robot service provider 17B.

The memory 1240 may store instructions (or programs) executable by the processor 1220. For example, the instructions may include instructions for performing an operation of the processor 1220 and/or an operation of each component of the processor 1220.

The memory 1240 may include one or more computer-readable storage media. The memory 1240 may include non-volatile storage elements (e.g., a magnetic hard disk, an optical disc, a floppy disc, flash memory, EPROM, and EEPROM).

The memory 1240 may be a non-transitory medium. The term "non-transitory" may indicate that a storage medium is not embodied in a carrier wave or a propagated signal. However, the term "non-transitory" should not be interpreted to mean that the memory 1240 is non-movable.

The processor 1220 may process data stored in the memory 1240. The processor 1220 may execute computer-readable code (e.g., software) stored in the memory 1240 and instructions triggered by the processor 1220.

The processor 1220 may be a hardware-implemented data processing device with a physically structured circuit to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

The processor 1220 may cause the delivery robot service provider 1200 to perform one or more operations by executing the code, instructions, and/or applications stored in the memory 1240. The operations performed by the delivery robot service provider 1200 may be substantially the same as the operations performed by the delivery robot service provider 17 described with reference to FIGS. 1 to 10. Accordingly, a repeated description thereof is omitted.

The communication module 1260 may establish a communication channel (e.g., a wireless communication channel) for communication. The communication module 1260 may support the communication through the established communication channel. The communication module 1260 may include one or more communication processors configured to support direct (or wired) communication or wireless communication. The communication module 1260 may include a wireless communication module (e.g., a cellular communication module, a short-range wireless communication module, or a GNSS communication module) or a wired communication module (e.g., a LAN communication module or a PLC module).

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, control, process, and generate data in response to execution of the software. For purpose of simplicity, the description of a processing unit is used as singular; however, one skilled in the art will appreciate that a processing unit may include a plurality of processing elements and a plurality of types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Although the disclosure has been illustrated and explained with reference to various embodiments, it will be understood by those skilled in the art that the various embodiments are intended to be illustrative but not restrictive. It will be understood by those skilled in the art that various changes in forms and details may be made without departing from the true spirit and full scope of this disclosure including the scope of the attached claims and their equivalents. Also, it will be understood by those skilled in the art that any of the embodiments described herein may be used in conjunction with other embodiments described herein.

Therefore, other implementations, other examples, and equivalents to the claims are also within the scope of the following claims.

What is claimed is:

1. A method of operating a first delivery robot, the method comprising:
receiving, when the first delivery robot meets a second delivery robot in commonly used infrastructure, an identifier of the second delivery robot and a first public key corresponding to the identifier from the second delivery robot;
receiving, when the first delivery robot meets a third delivery robot in the commonly used infrastructure, a second public key corresponding to the identifier of the second delivery robot from the third delivery robot;
determining whether the first public key is the same as the second public key; and
adjusting, based on the determining, a reliability of the second delivery robot.

2. The method of claim 1, wherein the adjusting of the reliability of the second delivery robot comprises:
increasing the reliability of the second delivery robot when the first public key is the same as the second public key; and
decreasing the reliability of the second delivery robot when the first public key is not the same as the second public key.

3. The method of claim 2, further comprising:
determining the second delivery robot to be an unreliable delivery robot when the reliability of the second delivery robot is less than a threshold reliability.

4. The method of claim 3, further comprising:
transmitting, when the first delivery robot meets the second delivery robot in the commonly used infrastructure after the second delivery robot is determined to be the unreliable delivery robot, information indicating that the second delivery robot is the unreliable delivery robot to a first delivery robot service provider that manages the first delivery robot.

5. The method of claim 1, further comprising:
registering the identifier of the second delivery robot in a first identifier ledger of the first delivery robot.

6. The method of claim 5, wherein the registering of the identifier of the second delivery robot comprises:
generating a current block in which the identifier of the second delivery robot is registered through a block generation operation between a previous block of the first identifier ledger and the first public key.

7. The method of claim 6, wherein the determining of whether the first public key is the same as the second public key comprises:
generating the first public key based on the previous block and the current block; and
determining whether the generated first public key is the same as the second public key.

8. The method of claim 5, wherein the first identifier ledger is a ledger in which identifiers of delivery robots met by the first delivery robot are registered.

9. The method of claim 1, wherein a second identifier ledger, which is a ledger in which identifiers of delivery robots met by the third delivery robot are registered, comprises the identifier of the second delivery robot.

10. A first delivery robot comprising:
a processor; and
a memory configured to store instructions,
wherein the instructions, when executed by the processor, cause the first delivery robot to perform a plurality of operations, the plurality of operations comprising:
receiving, when the first delivery robot meets a second delivery robot in commonly used infrastructure, an identifier of the second delivery robot and a first public key corresponding to the identifier from the second delivery robot;
receiving, when the first delivery robot meets a third delivery robot in the commonly used infrastructure, a second public key corresponding to the identifier of the second delivery robot from the third delivery robot;
determining whether the first public key is the same as the second public key; and
adjusting, based on the determining, a reliability of the second delivery robot.

11. The first delivery robot of claim 10, wherein the adjusting of the reliability of the second delivery robot comprises:
increasing the reliability of the second delivery robot when the first public key is the same as the second public key; and
decreasing the reliability of the second delivery robot when the first public key is not the same as the second public key.

12. The first delivery robot of claim 11, wherein the plurality of operations further comprises:
determining the second delivery robot to be an unreliable delivery robot when the reliability of the second delivery robot is less than a threshold reliability.

13. The first delivery robot of claim 12, wherein the plurality of operations further comprises:
transmitting, when the first delivery robot meets the second delivery robot in the commonly used infrastructure after the second delivery robot is determined to be the unreliable delivery robot, information indicating that the second delivery robot is the unreliable delivery robot to a first delivery robot service provider that manages the first delivery robot.

14. The first delivery robot of claim 10, wherein the plurality of operations further comprises:
registering the identifier of the second delivery robot in a first identifier ledger of the first delivery robot.

15. The first delivery robot of claim 14, wherein the registering of the identifier of the second delivery robot comprises:
generating a current block in which the identifier of the second delivery robot is registered through a block generation operation between a previous block of the first identifier ledger and the first public key.

16. The first delivery robot of claim 15, wherein the determining of whether the first public key is the same as the second public key comprises:
generating the first public key based on the previous block and the current block; and
determining whether the generated first public key is the same as the second public key.

17. The first delivery robot of claim 14, wherein the first identifier ledger is a ledger in which identifiers of delivery robots met by the first delivery robot are registered.

18. The first delivery robot of claim 16, wherein a second identifier ledger, which is a ledger in which identifiers of delivery robots met by the third delivery robot are registered, comprises the identifier of the second delivery robot.
